(19) United States
(12) Patent Application Publication
(10) Pub. No.: US 2023/0334484 A1
(43) Pub. Date: Oct. 19, 2023

(54) METHOD AND METAVERSE IMPLEMENTATION SYSTEM FOR IMPLEMENTING SUPPLY CHAIN SERVICE AND FINANCIAL SERVICE IN METAVERSE

(71) Applicant: aiZEN Global Co., Inc., Seoul (KR)

(72) Inventor: Jung Seok KANG, Seoul (KR)

(21) Appl. No.: 18/051,078

(22) Filed: Oct. 31, 2022

(30) Foreign Application Priority Data
Apr. 18, 2022 (KR) 10-2022-0047696

(51) Int. Cl. G06Q 20/38; G06Q 20/40

(52) U.S. Cl. CPC G06Q 20/389; G06Q 20/401

(57) ABSTRACT

A method and metaverse implementation system for implementing a supply chain service and a financial service in a metaverse can include implementing, by a first metaverse implementation device, a first metaverse related to a supply chain service, implementing, by a second metaverse implementation device, a second metaverse related to a financial service, and causing, by an inter-metaverse interoperation network implementation device, the first metaverse and the second metaverse to interoperate.

### BACKGROUND

### 1. Field of the Invention

The present invention relates to a method of implementing a supply chain service and a financial service in a metaverse and a device for performing the method. More particularly, the present invention relates to a method and device for implementing a supply chain service and a financial service in a virtualized space by implementing the supply chain service and the financial service in a metaverse.

### 2. Discussion of Related Art

There is a growing trend for major companies to provide metaverse platforms and content, and as investment and technology development increase, the market related to newly released financial products related to metaverses is growing.

Naver launched its metaverse platform Zepeto in 2018, and the number of users has now exceeded 200 million. Roblox of the US has become very popular as a gaming platform, and the number of daily active users (DAUs) was 46.6 million as of June 2021 which was an increase of 28% compared to July 2020.

For technological innovation in the metaverse field, global big tech companies, such as Facebook, Apple, Microsoft, etc., are presenting investments and visions and are actively pursuing team reorganization, tech company undertaking, etc. Further, domestic and foreign financial companies are launching various financial products, such as metaverse-related funds, exchange traded funds (ETFs), exchange traded notes (ETNs), etc., increasing people's interest in investment.

In the financial industry, information transmission and customer convenience are expected to be improved through a metaverse, and an increasing number of financial companies are providing services related to a metaverse such as virtual reality (VR), augmented reality (AR), etc.

As the scope of use of metaverses expands with the development of technology, the basis of various communication activities including finance may move from the mobile environment to a metaverse (a virtual world). When a metaverse environment is established, the visual constraint of a smartphone display can be overcome, and the communication method can also be expanded from touch to voice or movement.

Financial companies can transmit accurate and detailed information, and customers can conveniently use a service without visiting a store. Such a metaverse technology can be used not only in the financial industry but also in the distribution industry such as logistics. The metaverse technology makes it possible to make a more accurate and intuitive determination on the distribution and states of products, and new services can also be created by applying a metaverse to various fields.

As the related art, there is Korean Unexamined Patent Application No. 10-2021-0116417.

### SUMMARY OF THE INVENTION

The present invention is directed to resolving all the problems described above.

The present invention is also directed to implementing supply chain services and financial services in a metaverse so that users intuitively check and receive the supply chain services and the financial services.

The present invention is also directed to providing various levels of metaverse environments for supply chain services and financial services.

According to an aspect of the present invention, there is provided a method of implementing a supply chain service and a financial service in a metaverse, the method comprises implementing, by a first metaverse implementation device, a first metaverse related to a supply chain service, implementing, by a second metaverse implementation device, a second metaverse related to a financial service and causing, by an inter-metaverse interoperation network implementation device, the first metaverse and the second metaverse to interoperate.

Meanwhile, the first metaverse interoperates with a first blockchain network, the second metaverse interoperates with a second blockchain network, interoperation between the first metaverse and the second metaverse includes a process in the second metaverse based on first metaverse data generated in the first metaverse and a process in the first metaverse based on second metaverse data generated in the second metaverse and a third blockchain network is implemented for the interoperation between the first metaverse and the second metaverse.

Further, the first metaverse implementation device includes a first data processing server group and a first metaverse data processing server group, the first data processing server group includes a plurality of data processing servers configured to generate first data by processing data generated in the supply chain service, and the first metaverse data processing server group generates the first metaverse data by processing the first data.

According to another aspect of the present invention, there is provided a metaverse implementation system for implementing a supply chain service and a financial service in a metaverse, the metaverse implementation system comprises a first metaverse implementation device configured to implement a first metaverse related to a supply chain service, a second metaverse implementation device configured to implement a second metaverse related to a financial service and an inter-metaverse interoperation network implementation device configured to cause the first metaverse and the second metaverse to interoperate.

Meanwhile, the first metaverse interoperates with a first blockchain network, the second metaverse interoperates with a second blockchain network, interoperation between the first metaverse and the second metaverse includes a process in the second metaverse based on first metaverse data generated in the first metaverse and a process in the first metaverse based on second metaverse data generated in the second metaverse and a third blockchain network is implemented for the interoperation between the first metaverse and the second metaverse.

Further, the first metaverse implementation device includes a first data processing server group and a first metaverse data processing server group, the first data processing server group includes a plurality of data processing servers configured to generate first data by processing data generated in the supply chain service, and the first metaverse data processing server group generates the first metaverse data by processing the first data.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a conceptual diagram of a metaverse implementation system according to an exemplary embodiment of the present invention.

FIG. 2 is a conceptual diagram of a first metaverse implementation device according to an exemplary embodiment of the present invention.

FIG. 3 is a conceptual diagram of a second metaverse implementation device according to an exemplary embodiment of the present invention.

FIG. 4 is a conceptual diagram illustrating a method of implementing a metaverse on the basis of a plurality of servers included in a first data processing server group according to an exemplary embodiment of the present invention.

FIG. 5 is a conceptual diagram illustrating a plurality of servers included in a second data processing server group according to an exemplary embodiment of the present invention.

FIG. 6 is a conceptual diagram illustrating metaverse data generation according to an exemplary embodiment of the present invention.

FIG. 7 is a conceptual diagram illustrating operations of a metaverse data processor according to an exemplary embodiment of the present invention.

FIG. 8 is a conceptual diagram illustrating operations for interoperation between metaverses according to an exemplary embodiment of the present invention.

### DETAILED DESCRIPTION OF EXEMPLARY EMBODIMENTS

The detailed description of the present invention will be made with reference to the accompanying drawings showing examples of specific embodiments of the present invention. These embodiments will be described in detail such that the present invention can be performed by those skilled in the art. It should be understood that various embodiments of the present invention are different but are not necessarily mutually exclusive. For example, a specific shape, structure, and characteristic of an embodiment described herein may be implemented in another embodiment without departing from the scope and spirit of the present invention. In addition, it should be understood that a position or arrangement of each component in each disclosed embodiment may be changed without departing from the scope and spirit of the present invention. Accordingly, there is no intent to limit the present invention to the detailed description to be described below. The scope of the present invention is defined by the appended claims and encompasses all equivalents that fall within the scope of the appended claims. Like reference numerals refer to the same or like elements throughout the description of the figures.

Hereinafter, in order to enable those skilled in the art to practice the present invention, exemplary embodiments of the present invention will be described in detail with reference to the accompanying drawings.

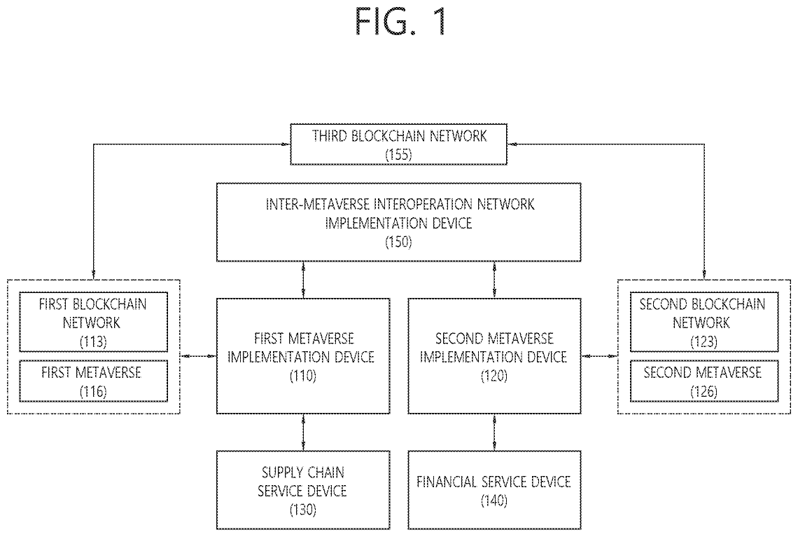

FIG. 1 is a conceptual diagram of a metaverse implementation system according to an exemplary embodiment of the present invention.

FIG. 1 shows a metaverse implementation system for implementing supply chain services and financial services in a metaverse.

Referring to FIG. 1, the metaverse implementation system may include a first metaverse implementation device 110, a second metaverse implementation device 120, an inter-metaverse interoperation network implementation device 150, a supply chain service device, and a financial service device 140.

The first metaverse implementation device 110 may be intended for a metaverse related to supply chain services. The metaverse related to supply chain services may be called a “first metaverse 116.” The first metaverse 116 may interoperate with a first blockchain network 113, and some data may be processed on the basis of the first blockchain network 113.

The second metaverse implementation device 120 may be intended for a metaverse related to financial services. The metaverse related to financial services may be called a “second metaverse 126.” The second metaverse 126 may interoperate with a second blockchain network 123, and some data may be processed on the basis of the second blockchain network 123.

The inter-metaverse interoperation network implementation device 150 may be intended for interoperation between the first metaverse 116 and the second metaverse 126. Interoperation between metaverses may be performed for a process in the second metaverse 126 based on first metaverse data generated in the first metaverse 116 and a process in the first metaverse 116 based on second metaverse data generated in the second metaverse 126. The inter-metaverse interoperation network implementation device 150 may define an additional third blockchain network 155 for inter-metaverse interoperation.

The supply chain service device 130 is a device that provides supply chain-based services. The supply chain service device 130 may provide product distribution data generated in supply chains. Supply chain data may cause a product distribution action in the first metaverse 116 and a change in a metaverse environment. Also, at least one piece of supply chain data may be recorded in the first blockchain network 113.

The financial service device 140 is a device that provides financial services. The financial service device 140 may provide financial service data generated in financial services. Financial service data may cause a financial action in the second metaverse 126 and a change in a metaverse environment. Also, at least one piece of financial service data may be recorded in the second blockchain network 123.

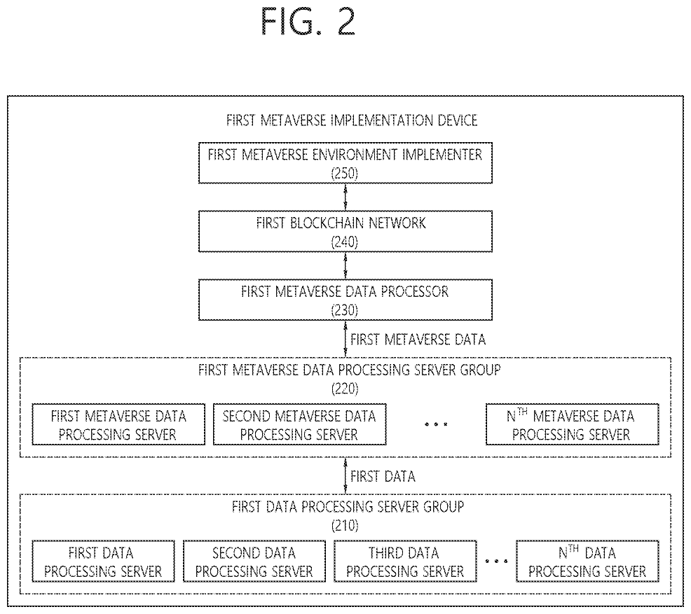

FIG. 2 is a conceptual diagram of a first metaverse implementation device according to an exemplary embodiment of the present invention.

FIG. 2 shows a first metaverse implementation device for implementing a metaverse related to supply chain services.

Referring to FIG. 2, the first metaverse implementation device may include a first data processing server group 210, a first metaverse data processing server group 220, a first metaverse data processor 230, a first blockchain network 240, and a first metaverse environment implementer 250.

The first data processing server group 210 may include data processing servers that process supply chain data generated in supply chain services. The supply chain services may provide services related to product distribution, such as product production, sales, storage, distribution, purchase, etc., and may collect and process supply chain data which is data generated from product distribution.

The plurality of data processing servers included in the first data processing server group 210 may be stratified, and data of the data processing servers collected by layer may be selectively used to implement a metaverse. The first metaverse environment implementer 250 may implement supply chain services in a metaverse on the basis of data generated by at least one data processing server located in each layer.

For convenience of description, data generated by the first data processing server group 210 may be called “first data” below.

The first metaverse data processing server group 220 may be intended to process data required in a metaverse. The first metaverse data processing server group 220 may generate first metaverse data by processing first data generated by the first data processing server group 210.

A plurality of metaverse data processing servers included in the first metaverse data processing server group 220 may separately interoperate with the plurality of data processing servers included in the first data processing server group 210. The plurality of data processing servers may separately transmit data to the plurality of interoperating metaverse data processing servers, and each of the plurality of metaverse data processing servers may process the received data to generate first metaverse data.

The first metaverse data generated by the first metaverse data processing server group 220 may be transmitted to the first metaverse data processor 230.

The first metaverse data processor 230 may receive and process the first metaverse data and transmit the processed data to the first blockchain network 240 and the first metaverse environment implementer 250. Specifically, the first metaverse data processor 230 may classify the first metaverse data as data to be recorded in the first blockchain network 240 or data to be recorded in the first metaverse environment implementer 250.

After the first metaverse data is classified, processed data may be transmitted to the first blockchain network 240 and the first metaverse environment implementer 250 in real time or periodically.

The first blockchain network 240 may be intended to receive and record the first metaverse data on a blockchain. The first blockchain network 240 may include a smart contract for processing the first metaverse data and implement a metaverse environment by processing the first metaverse data on the basis of the stored smart contract.

The first metaverse environment implementer 250 may implement a first metaverse environment on the basis of the first metaverse data. The first metaverse environment may be an environment corresponding to a supply chain in a metaverse. The first metaverse environment may include a first common metaverse environment that is implemented in common and a first individual metaverse environment for individual users and individual user groups. The first metaverse environment enables a user to check that a supply chain service is provided for a product in a metaverse space, and the supply chain service can be extended to another service (e.g., a financial service) based on the supply chain checked in the metaverse.

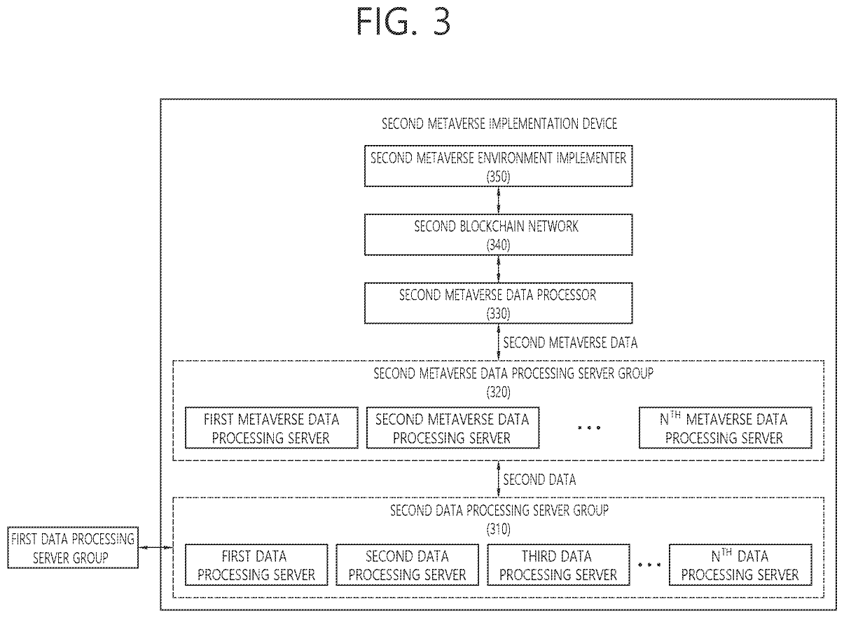

FIG. 3 is a conceptual diagram of a second metaverse implementation device according to an exemplary embodiment of the present invention.

FIG. 3 shows a second metaverse implementation device for implementing a metaverse related to financial services.

Referring to FIG. 3, the second metaverse implementation device may include a second data processing server group 310, a second metaverse data processing server group 320, a second metaverse data processor 330, a second blockchain network 340, and a second metaverse environment implementer 350.

The second data processing server group 310 may include data processing servers that process data generated in financial services. The financial services may provide finance-related services, such as a loan, an interest rate, a repayment, an investment, a deposit, etc., and may collect and process financial data which is data generated in the financial services.

The plurality of data processing servers included in the second data processing server group 310 may be stratified, and data of the data processing servers collected by layer may be selectively used to implement a metaverse. The second metaverse environment implementer 350 may implement financial services in the metaverse on the basis of data generated by at least one data processing server located in each layer.

For convenience of description, data generated by the second data processing server group 310 may be called “second data” below.

A network may be present between the above-described first data processing server group and the second data processing server group 310, and data may be exchanged through the network between the first data processing server group and the second data processing server group 310. For example, when an interaction occurs between the first metaverse environment and a second metaverse environment, data may be exchanged between the first metaverse environment and the second metaverse environment. The exchanged data may be transmitted in a separate format to the inter-metaverse interoperation network implementation device to allow inter-metaverse interaction.

The second metaverse data processing server group 320 may be intended to process data required in a metaverse. The second metaverse data processing server group 320 may generate second metaverse data by processing second data generated by the second data processing server group 310.

A plurality of metaverse data processing servers included in the second metaverse data processing server group 320 may separately interoperate with the plurality of data processing servers included in the second data processing server group 310. The plurality of data processing servers may separately transmit data to the plurality of interoperating metaverse data processing servers, and each of the plurality of metaverse data processing servers may process the received data to generate second metaverse data.

The second metaverse data generated by the second metaverse data processing server group 320 may be transmitted to the second metaverse data processor 330.

The second metaverse data processor 330 may receive and process the second metaverse data and transmit the processed data to the second blockchain network 340 and the second metaverse environment implementer 350. Specifically, the second metaverse data processor 330 may classify the second metaverse data as data to be recorded in the second blockchain network 340 or data to be recorded in the second metaverse environment implementer 350.

After the second metaverse data is classified, processed data may be transmitted to the second blockchain network 340 and the second metaverse environment implementer 350 in real time or periodically.

The second blockchain network 340 may be intended to receive and record the second metaverse data on a blockchain. The second blockchain network 340 may include a smart contract for processing the second metaverse data and implement a metaverse environment by processing the second metaverse data on the basis of the stored smart contract.

The second metaverse environment implementer 350 may implement a second metaverse environment on the basis of the second metaverse data. The second metaverse environment may be an environment corresponding to financial services in the metaverse. The second metaverse environment may include a second common metaverse environment that is implemented in common and a second individual metaverse environment for individual users and individual user groups. The second metaverse environment enables a user to check that a financial service is provided in a metaverse space, and the financial service can be extended to another service (e.g., a supply chain service) based on the financial service checked in the metaverse.

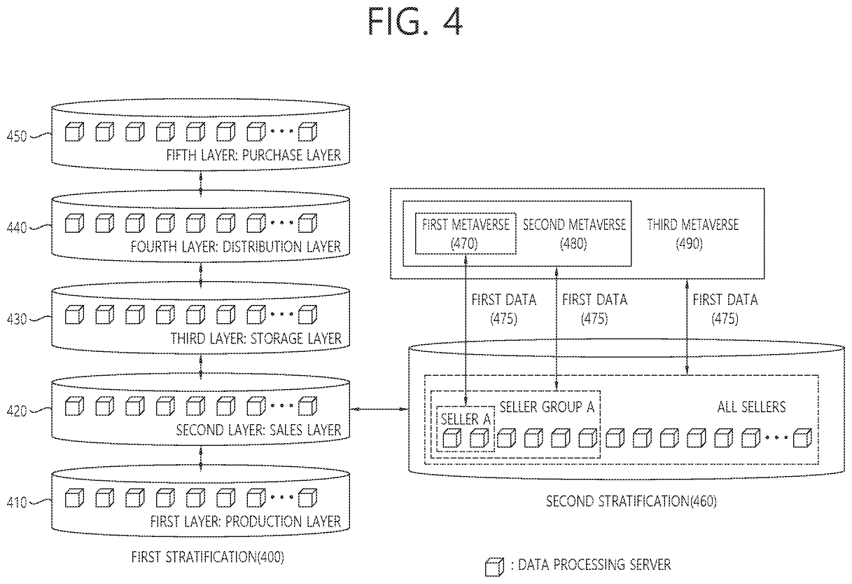

FIG. 4 is a conceptual diagram illustrating a method of implementing a metaverse on the basis of a plurality of servers included in a first data processing server group according to an exemplary embodiment of the present invention.

FIG. 4 shows an operation of stratifying a first data processing server group to implement a metaverse on the basis of a supply chain service.

Referring to FIG. 4, a first data processing server group for a supply chain service may be primarily stratified 400 into first to nth layers, from a lower layer to a higher layer.

A plurality of data processing servers may be servers that collect supply chain data generated in a supply chain, and the layers of the plurality of data processing servers may be determined by considering generation of data from the supply chain. Actions such as production, sales, storage, distribution, purchase, etc. may sequentially occur in the supply chain. These actions in the supply chain may be performed while transmitting data from a lower layer to a higher layer. For example, a first layer 410, a second layer 420, a third layer, 430, a fourth layer 440, and a fifth layer 450 may be set as a production layer, a sales layer, a storage layer, a distribution layer, and a purchase layer, respectively. Accordingly, a process of generating a product to a process of transferring the product to a purchaser through a sales procedure may be stratified.

Production, sales, storage, distribution, and purchase are examples of actions occurring in the supply chain, and actions occurring in the supply chain may be defined as various other service operations.

A plurality of data processing servers in the same layer may be classified again by metaverse environment or secondarily stratified 460. For example, a metaverse environment may be implemented in various dimensions such as a first metaverse 470 for seller A, a second metaverse 480 for seller group A including seller A, a third metaverse 490 for all sellers, etc. Alternatively, a metaverse environment may be implemented in various dimensions such as a fourth metaverse for product A rather than seller A, a fifth metaverse for product group A including product A, a sixth metaverse for all products, etc.

A metaverse environment may be variously implemented depending on variables (e.g., a seller and a product) for implementing the metaverse environment and variable settings (individual variables, a variable group, all variables, etc.), and data processing servers of the same layer may be classified again to implement a metaverse environment and secondarily stratified 460.

A method of implementing a first metaverse and a second metaverse respectively for seller A and seller group A will be illustrated.

First Metaverse 470

Data processing servers related to seller A may be classified and grouped. When seller A sells products at Naver Smart Store, data processing server 1 corresponding to Coupang and data processing server 2 corresponding to Naver Smart Store may be classified as data processing servers for implementing the first metaverse 470 and grouped.

First data 475 generated at each of the first server and the second server in accordance with a seller may be collected by the first data processing server group and transmitted to a first metaverse data processing server group. First metaverse data for generating the first metaverse 470 may be generated at the first metaverse data processing server group and transmitted to a first metaverse data processor.

(2) Second Metaverse 480

Servers related to seller group A may be classified and grouped. Seller group A may be a seller group having a sales characteristic similar to that of seller A. Seller group A may sell products on various platforms (Coupang, Naver Smart Store, 11Street, Gmarket, etc.). Each of a plurality of servers corresponding to various platforms may be classified as a server for implementing the second metaverse 480 and grouped.

The second metaverse 480 has a structure including the first metaverse 470, and at least one server for the first metaverse 470 may be included in the plurality of servers for the second metaverse 480 or stratified. At least one server that collects data about each of seller A, seller A1, seller A2, . . . , and seller A3 included in seller group A may be stratified and become a server that collects data corresponding to seller group A.

Likewise, first data generated in accordance with seller group A may be collected by the first data processing server group and transmitted to the first metaverse data processing server group. First metaverse data for generating the second metaverse 480 may be generated at the first metaverse data processing server group and transmitted to the first metaverse data processor.

In this way, data processing servers may be stratified or grouped in accordance with a setting so that metaverse environments for individual sellers, individual seller groups, individual products, product groups, etc. can be adaptively implemented as necessary.

According to an exemplary embodiment of the present invention, for efficient data processing, data transmission may be performed by considering a metaverse structure. For example, first data for a first metaverse may also be first data for a second metaverse and a third metaverse including the first metaverse. Also, the first data for the second metaverse may be the first data for the third metaverse including the second metaverse. Accordingly, selective transmission in which the relationship between metaverses is taken into consideration may be performed on the basis of a first layer header and a second layer header included in the first data generated to prevent overlapping data processing. The relationship between metaverses may be determined on the basis of the first layer header and the second layer header, and metaverse data may be classified on the basis of the first layer header and the second layer header and transmitted to a metaverse environment implementer.

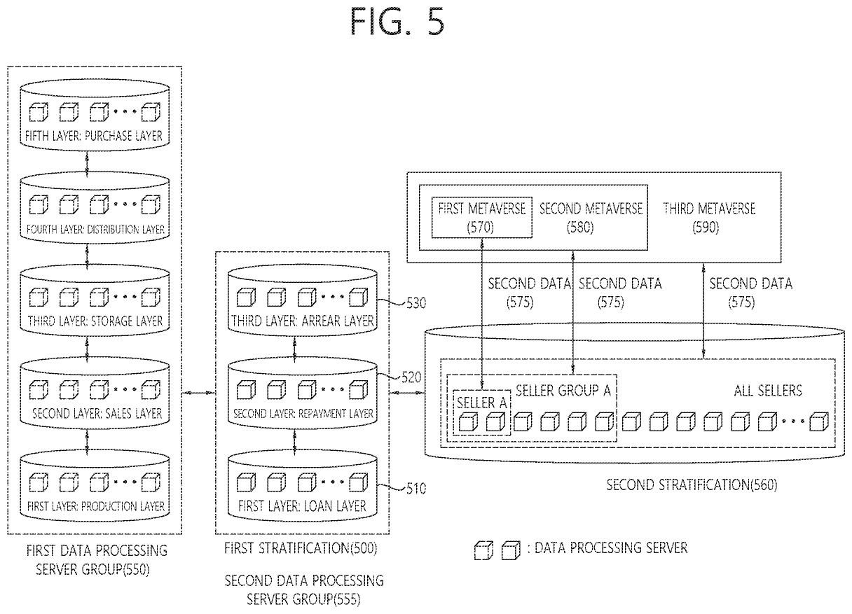

FIG. 5 is a conceptual diagram illustrating a plurality of servers included in a second data processing server group according to an exemplary embodiment of the present invention.

FIG. 5 shows an operation of stratifying a second data processing server group to provide a financial service.

Referring to FIG. 5, a second data processing server group 555 for a financial service may be stratified 500 into first to nth layers, from a lower layer to a higher layer.

A plurality of servers may be data processing servers that collect financial service data generated in a financial service, and the layers of the plurality of servers may be determined by considering generation of data from the financial service. Actions such as loan, a repayment (interest or the principal), an arrear, etc. may sequentially occur in the financial service. These actions in the financial service may be performed while transmitting data from a lower layer to a higher layer. For example, a first layer, a second layer, and a third layer may be set as a loan layer 510, a repayment layer 520, and an arrear layer 530, respectively. Accordingly, a process of providing the financial service to a process of completing the financial service may be stratified.

Loan, repayment, and arrear are examples of actions occurring in the financial service, and actions occurring in the financial service may be defined as various other service operations.

A plurality of servers in the same layer may be classified again by metaverse environment or secondarily stratified 560. Like in a supply chain service, a metaverse environment may be implemented in various dimensions such as a first metaverse 570 for seller A, a second metaverse 580 for seller group A including seller A, a third metaverse 590 for all sellers, etc.

While a financial service is provided to each individual seller, characteristics of a seller group including the seller and all sellers may be reflected to determine the financial service provided to the individual seller. For example, seller A may be a seller who sells women's clothes, and seller group A may be a seller group including a plurality of sellers who sell women's clothes.

To provide a financial service to seller A, it may be necessary to collect not only supply chain data of seller A but also supply chain data of seller group A.

Accordingly, a server for financial services may collect supply chain data in connection with a server layer for a supply chain service and provide a financial service on the basis of the supply chain data. A plurality of servers included in the second data processing server group 555 may interoperate with a plurality of servers included in the first data processing server group 550 to provide a financial service.

In this way, the second data processing server group 555 may be subordinate to the first data processing server group 550 to receive not only financial service data but also supply chain data for a financial service and generate second data 575.

The second data 575 may be transmitted to a second metaverse data processing server group, and second metaverse data for generating the first metaverse 570, the second metaverse 580, and the third metaverse 590 may be generated at a second metaverse data processing group. The second metaverse data may be transmitted to a second metaverse data processor.

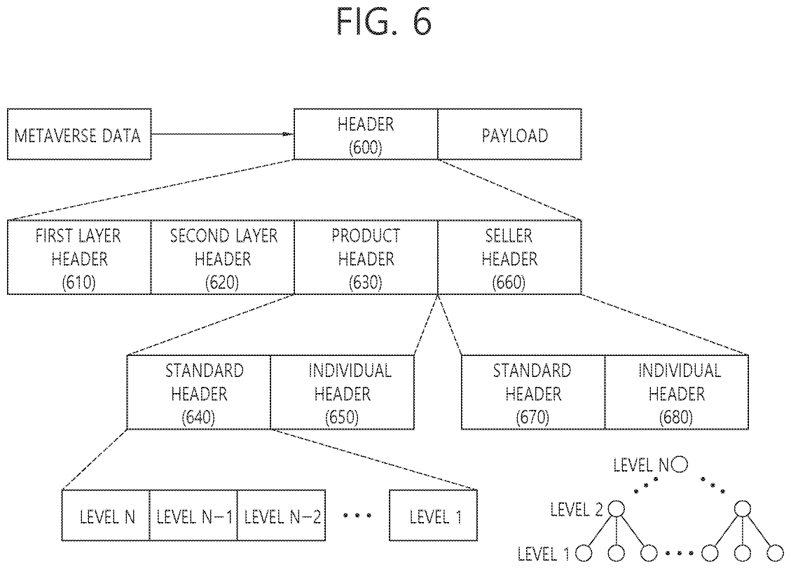

FIG. 6 is a conceptual diagram illustrating metaverse data generation according to an exemplary embodiment of the present invention.

FIG. 6 shows a metaverse data generation operation of a metaverse data processing server group.

Referring to FIG. 6, a metaverse data processing server group may generate metaverse data to be transmitted to a metaverse data processor from received data.

The metaverse data may be generated by adding metaverse header information to the received data in accordance with a setting.

A header 600 of the metaverse data may include first hierarchy information and second hierarchy information of a data processing server group, seller information, and product information.

The first hierarchy information is hierarchy information stratified through the above-described first stratification and may include information on a first layer at which data is generated.

The second hierarchy information is hierarchy information stratified through the above-described second stratification and may include information on a second layer at which data is generated.

The seller information may include information for classifying sellers who sell products in a supply chain and receive a financial service.

The product information may include information for classifying products that are distributed and sold in the supply chain and underlie a financial service.

A metaverse may be implemented on the basis of various variables (sellers, products, etc.), and the header 600 of metaverse data may be added to provide a metaverse environment in which various variables are taken into consideration.

The header 600 may include a first layer header 610, a second layer header 620, a product header 630, and a seller header 660. The product header 630 may be divided into a standard header 640 and an individual header 650, and the seller header 660 may be divided into a standard header 670 and an individual header 680.

Each of the standard header 640 and the individual header 650 of the product header 630 may be set to n header levels.

The standard header 640 may include n header levels for product classifications defined as a standard for integration between different metaverses. The individual header 650 may include n header levels for product classifications which are separately defined to manage only a specific metaverse. A plurality of different supply chains and financial services may be implemented in an integrative manner through a metaverse on the basis of the standard header 640, and the individual header 650 may be defined so that a metaverse may be adaptively implemented for an individual supply chain and an individual financial service as necessary.

n header levels of each of the standard header 640 and the individual header 650 in the product header 630 may have a hierarchical structure, and each of the n header levels may have a more comprehensive concept when set to a higher layer. For example, a first header level of the standard header 640 may correspond to pencils, a second header level may correspond to stationery, a third header level may correspond to industrial products, and the like. In other words, a higher layer may be set to a wider concept including the corresponding product. n header levels corresponding to the product header 630 may vary depending on a setting, and a change may be made to the header 600 in accordance with such a change.

Likewise, each of the standard header 670 and the individual header 680 of the seller header 660 may be set to m header levels. m header levels of each of the standard header 670 and the individual header 680 in the seller header 660 may have a hierarchical structure, and each of the m header levels may have a more comprehensive concept when set to a higher layer. For example, a first header level of the standard header 670 may correspond to seller A, a second header level may correspond to a first seller group, a third header level may correspond to a second seller group, and the like. In other words, a higher layer may be set to a wider concept including the corresponding seller or seller group. m header levels corresponding to the seller header 660 may vary depending on a setting, and a change may be made to the header 600 in accordance with such a change.

A level of a header that is not set for the product header 630 and the seller header 660 as unnecessary may be left without any setting.

Also, according to an exemplary embodiment of the present invention, the standard headers 640 and 670 may be adjusted on the basis of use of the individual headers 650 and 680. For example, in consideration of the individual headers 650 and 680 used in a specific metaverse, the standard headers 640 and 670 may be adjusted in accordance with actual classifications for business to reflect information on a header level which is frequently used in practice. Also, a header for only a specific metaverse environment may be additionally defined by considering a metaverse implementation environment and used to implement only the metaverse.

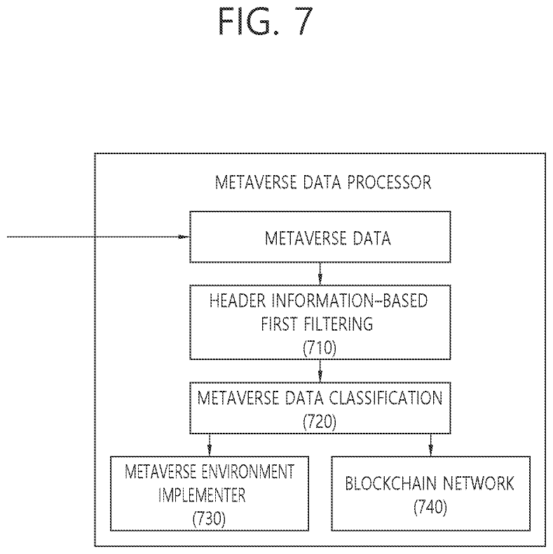

FIG. 7 is a conceptual diagram illustrating operations of a metaverse data processor according to an exemplary embodiment of the present invention.

FIG. 7 shows metaverse data processing operations of a metaverse data processor.

Referring to FIG. 7, a metaverse data processor may receive and process metaverse data and transmit the processed data to a blockchain network 740 and a metaverse environment implementer 730.

The metaverse data processor may classify the metaverse data into data to be recorded in the blockchain network 740 or data to be recorded in the metaverse environment implementer 730.

The metaverse data processor may perform header information-based first filtering 710. First, metaverse data that is currently not required for implementing a metaverse environment may be removed in consideration of the metaverse environment to be implemented. For example, when a metaverse environment is not requested for seller B and product X, metaverse data about seller B and product X may be filtered out.

After the first filtering 710, the metaverse data processor may transmit the metaverse data to the metaverse environment implementer through metaverse data classification 720. For example, when a metaverse is to be implemented for seller A and seller group A, metaverse data corresponding to each of seller A and seller group A is classified through header filtering and transmitted to the metaverse environment implementer 730.

The metaverse data processor may generate hash values by grouping the metaverse data for recording on the blockchain and store the generated hash values on the blockchain network 740. In the present invention, time units may be set for each metaverse, and hash values of the metaverse data collected in the time units may be recorded on the blockchain network 740.

For example, first time units and second time units may be set for seller A and seller group A, respectively. Metaverse data about seller A generated in the first time units may be grouped and generated as hash values together with identification information of seller A. The generated hash values may be stored on the blockchain network 740. Likewise, metaverse data about seller group A generated in the second time units may be grouped and generated as hash values together with identification information of seller group A. The generated hash values may be stored on the blockchain network 740. The first time units and the second time units may be adjusted on the basis of a generation speed of the metaverse data. When the generation speed of the metaverse data is higher, time units may be set to be shorter.

According to an exemplary embodiment of the present invention, among metaverse data, metaverse data (time) in which time is highly regarded may not be grouped in time units but may be stored on a blockchain network first. For example, among supply chain data, data of products having an expiration date may not be grouped in time units but may be stored on the blockchain upon generation. Also, metaverse data in which time is highly regarded, such as the time of loan, the time of repayment, and the time of arrear related to a financial service may be immediately recorded on the blockchain without considering time units.

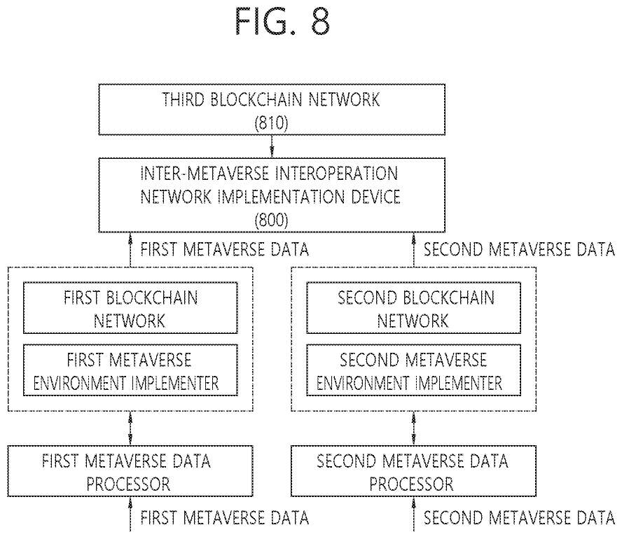

FIG. 8 is a conceptual diagram illustrating operations for interoperation between metaverses according to an exemplary embodiment of the present invention.

FIG. 8 shows operations for interoperation between a first metaverse based on a supply chain service and a second metaverse based on a financial service.

Referring to FIG. 8, first metaverse data generated on the basis of the supply chain service may be processed by a first metaverse data processor and transmitted to a first blockchain network and a first metaverse environment implementer.

Second metaverse data generated on the basis of the financial service may be processed by a second metaverse data processor and transmitted to a second blockchain network and a second metaverse environment implementer.

In the present invention, second data may be partially determined on the basis of first data, and some of the second metaverse data may be subordinate to some of the first metaverse data. For example, a financial service may be provided by considering supply chain data, and metaverse data may be generated due to the financial service.

The first metaverse data and the second metaverse data which are dependent on each other and mutual dependency subject information (e.g., seller A, seller group A, product X, etc.) may be transmitted to an inter-metaverse interoperation network implementation device 800. The mutual dependency subject information may be information on subjects from which the first metaverse data and the second metaverse data dependent on each other are generated.

The inter-metaverse interoperation network implementation device 800 may store the mutual dependency subject information of the first metaverse data and the second metaverse data which are dependent on each other, process the first metaverse data and the second metaverse data related to the mutual dependency subjects, and store the processed first metaverse data and second metaverse data stored on a third blockchain network 810.

The first metaverse data is data related to the supply chain service and thus may be continuously generated, and the second metaverse data is data related to the financial service and thus may be generated intermittently compared to the first metaverse data. Accordingly, the first metaverse data may be periodically grouped and stored as a first format hash value on the third blockchain network 810. When the second metaverse data is generated, the first format hash value of each piece of previously grouped first metaverse data and the second format hash value of all the second metaverse data may be generated and stored on the third blockchain network 810.

When a financial service is provided on the basis of specific supply chain data through these operations, it is possible to track a change in supply chain data and a change in the financial service in a metaverse, and data can be verified on a blockchain as well. In this way, a first metaverse environment and a second metaverse environment can interact with each other.

The embodiments of the present invention described above may be implemented in the form of program instructions that can be executed through various computer units and recorded on computer readable media. The computer readable media may include program instructions, data files, data structures, or combinations thereof. The program instructions recorded on the computer readable media may be specially designed and prepared for the embodiments of the present invention or may be available instructions well known to those skilled in the field of computer software. Examples of the computer readable media include magnetic media such as a hard disk, a floppy disk, and a magnetic tape, optical media such as a compact disc read only memory (CD-ROM) and a digital video disc (DVD), magneto-optical media such as a floptical disk, and a hardware device, such as a ROM, a RAM, or a flash memory, that is specially made to store and execute the program instructions. Examples of the program instruction include machine code generated by a compiler and high-level language code that can be executed in a computer using an interpreter and the like. The hardware device may be configured as at least one software module in order to perform operations of embodiments of the present invention and vice versa.

While the present invention has been described with reference to specific details such as detailed components, specific embodiments and drawings, these are only examples to facilitate overall understanding of the present invention and the present invention is not limited thereto. It will be understood by those skilled in the art that various modifications and alterations may be made.

Therefore, the spirit and scope of the present invention are defined not by the detailed description of the present invention but by the appended claims, and encompass all modifications and equivalents that fall within the scope of the appended claims.

What is claimed is:

1. A method of implementing a supply chain service and a financial service in a metaverse, the method comprising:
implementing, by a first metaverse implementation device, a first metaverse related to a supply chain service;
implementing, by a second metaverse implementation device, a second metaverse related to a financial service; and
causing, by an inter-metaverse interoperation network implementation device, the first metaverse and the second metaverse to interoperate.

2. The method of claim 1, wherein the first metaverse interoperates with a first blockchain network,
the second metaverse interoperates with a second blockchain network,
interoperation between the first metaverse and the second metaverse includes a process in the second metaverse based on first metaverse data generated in the first metaverse and a process in the first metaverse based on second metaverse data generated in the second metaverse, and
a third blockchain network is implemented for the interoperation between the first metaverse and the second metaverse.

3. The method of claim 2, wherein the first metaverse implementation device includes a first data processing server group and a first metaverse data processing server group,
the first data processing server group includes a plurality of data processing servers configured to generate first data by processing data generated in the supply chain service, and
the first metaverse data processing server group generates the first metaverse data by processing the first data.

4. A metaverse implementation system for implementing a supply chain service and a financial service in a metaverse, the metaverse implementation system comprising:
a first metaverse implementation device configured to implement a first metaverse related to a supply chain service;
a second metaverse implementation device configured to implement a second metaverse related to a financial service; and
an inter-metaverse interoperation network implementation device configured to cause the first metaverse and the second metaverse to interoperate.

5. The metaverse implementation system of claim 4, wherein the first metaverse interoperates with a first blockchain network,
the second metaverse interoperates with a second blockchain network,
interoperation between the first metaverse and the second metaverse includes a process in the second metaverse based on first metaverse data generated in the first metaverse and a process in the first metaverse based on second metaverse data generated in the second metaverse, and
a third blockchain network is implemented for the interoperation between the first metaverse and the second metaverse.

6. The metaverse implementation system of claim 5, wherein the first metaverse implementation device includes a first data processing server group and a first metaverse data processing server group,
the first data processing server group includes a plurality of data processing servers configured to generate first data by processing data generated in the supply chain service, and
the first metaverse data processing server group generates the first metaverse data by processing the first data.
